(19) United States
(12) Patent Application Publication
(10) Pub. No.: US 2018/0050601 A1
(43) Pub. Date: Feb. 22, 2018

(54) ELECTRICALLY POWERED VEHICLE

(71) Applicant: Toyota Jidosha Kabushiki Kaisha, Toyota-shi (JP)

(72) Inventor: Tomoya Katanoda, Toyota-shi (JP)

(21) Appl. No.: 15/668,234

(22) Filed: Aug. 3, 2017

(30) Foreign Application Priority Data
Aug. 17, 2016 (JP) 2016-160044

(51) Int. Cl. B60L 11/18

(52) U.S. Cl. CPC B60L 11/1861; B60L 11/1857; B60L 2260/50; B60L 2240/70; B60L 11/1864

(57) ABSTRACT

Use history data of a main battery of an electrically powered vehicle is periodically accumulated in a memory. A data center calculates a standard deterioration degree over time of the main battery by using information on secondary batteries received from a plurality of electrically powered vehicles each provided with a vehicle-mounted secondary battery. A controller obtains the standard deterioration degree from the data center at prescribed deterioration diagnosis timing and increases an upper limit value of an SOC control range of the main battery when a deterioration degree estimated from the use history data of the main battery is lower than the standard deterioration degree.

### CROSS-REFERENCE TO RELATED APPLICATIONS

This application claims priority to Japanese Patent Application No. 2016-160044 filed on Aug. 17, 2016, the entire contents of which are hereby incorporated by reference.

### BACKGROUND

### Field

The present disclosure relates to an electrically powered vehicle and more particularly to an electrically powered vehicle incorporating a secondary battery.

### Description of the Background Art

A secondary battery is mounted on a vehicle as a power supply for driving a motor of an electric car and a hybrid car. A secondary battery has been known to suffer from increase in internal resistance or lowering in full charge capacity due to deterioration over time as it is used. In particular, when the full charge capacity becomes low, decrease in energy which can be recovered in regenerative braking during running and decrease in travel distance with energy stored in the secondary battery are concerned.

Japanese Patent No. 5126008 describes a battery diagnosis system for vehicle which determines remaining lifetime of a vehicle-mounted secondary battery by being connected to a vehicle brought to a maintenance and repair service such as a dealer. According to the battery diagnosis system for vehicle in Japanese Patent No. 5126008, diagnosis information on a secondary battery on which drive patterns of a driver and an environment where a vehicle is located is reflected are accumulated, and by using the accumulated diagnosis information, a control plan for extending lifetime of the secondary battery is presented or a control parameter is modified.

### SUMMARY

In estimating remaining lifetime (that is, a deterioration degree) of the secondary battery by using the accumulated diagnosis information as in Japanese Patent No. 5126008, it is important to improve estimation accuracy. If estimation of a deterioration degree is inaccurate, presentation of a control plan for extension of lifetime or modification to a control parameter cannot be sufficient and failure in sufficient suppression of deterioration of the secondary battery is concerned. Alternatively, in contrast, failure in effective use of the secondary battery due to excessive restriction of use is concerned.

Japanese Patent No. 5126008, however, fails to mention specific details of or control processing for diagnosis by using the accumulated information in the battery diagnosis system for vehicle. Whereas Japanese Patent No. 5126008 describes measures for extension of remaining lifetime to be taken by a user of a vehicle including a deteriorated secondary battery, it fails to provide advantages to a user of a vehicle including a secondary battery low in deterioration degree.

The present disclosure was made to solve such problems, and an object of the present disclosure is to enhance accuracy in estimation of a deterioration degree of a secondary battery mounted on an electrically powered vehicle and to make effective use of the secondary battery in accordance with the estimated deterioration degree.

In one aspect of the present disclosure, an electrically powered vehicle includes a secondary battery mounted as a motive power source, a memory, a communicator, and a controller. The memory is configured to accumulate use history data of the secondary battery. The communicator is configured to communicate with a data center outside the electrically powered vehicle. The controller is configured to control charging and discharging of the secondary battery so as to maintain an SOC of the secondary battery within a control range. The data center is configured to receive information on vehicle-mounted secondary batteries from a plurality of vehicles each provided with the vehicle-mounted secondary battery and to calculate a standard deterioration degree over time of the secondary batteries by using the information from the plurality of vehicles. The controller is configured to obtain the standard deterioration degree from the data center at prescribed deterioration diagnosis timing and to increase an upper limit value of the control range of the SOC when a deterioration degree estimated based on the use history data of the electrically powered vehicle is lower than the standard deterioration degree.

According to the electrically powered vehicle, whether or not a deterioration degree of a subject battery is lower than the standard can highly accurately be estimated by using actual infatuation on secondary batteries in a plurality of vehicles and a secondary battery of which deterioration degree is estimated to be lower than the standard can effectively be used by broadening an SOC available range by making use of a margin thereof.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a block diagram showing an exemplary configuration of an electrically powered vehicle according to an embodiment of the present disclosure.

FIG. 2 is a flowchart for illustrating processing for accumulating battery use history data of the electrically powered vehicle.

FIG. 3 is a flowchart illustrating control processing for diagnosing deterioration of a secondary battery in the electrically powered vehicle.

FIG. 4 is a scatter diagram of a battery temperature and an SOC based on battery use history data.

FIG. 5 is a histogram of a battery temperature in a certain SOC range obtained from the scatter diagram in FIG. 4.

FIG. 6 shows a table illustrating exemplary definition of a region of use of a secondary battery.

FIG. 7 shows a conceptual graph illustrating exemplary estimation of a deterioration curve.

FIG. 8 shows a conceptual graph illustrating one example of processing for comparing a deterioration curve of a subject car with a reference deterioration curve.

FIG. 9 is a conceptual diagram illustrating SOC control based on a result of diagnosis of deterioration of a secondary battery in the electrically powered vehicle according to the present embodiment.

FIG. 10 is a flowchart illustrating a modification of diagnosis of deterioration of the secondary battery in the electrically powered vehicle.

### DETAILED DESCRIPTION

An embodiment of the present disclosure will be described below in detail with reference to the drawings. The same or corresponding elements in the drawings below have the same reference characters allotted and description thereof will not be repeated in principle.

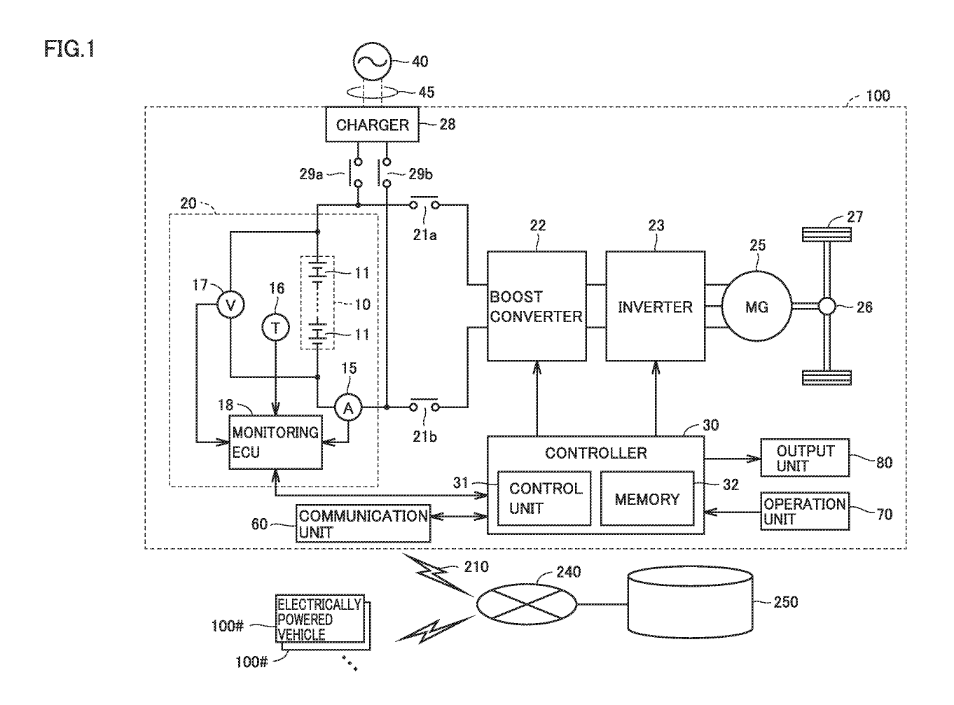

FIG. 1 is a block diagram showing an exemplary configuration of an electrically powered vehicle according to an embodiment of the present disclosure.

Referring to FIG. 1, a main battery 10 representing a vehicle-mounted secondary battery is mounted on an electrically powered vehicle 100. Electrically powered vehicle 100 is implemented, for example, as a hybrid car or an electric car including main battery 10 as a vehicle driving power supply (that is, a motive power source). The hybrid car is a vehicle including, in addition to a battery, a fuel cell or an engine which is not shown as a source of motive power for running the vehicle. The electric car is a vehicle including only a battery as a source of motive power of the vehicle. Electrically powered vehicle 100 includes main battery 10, a boost converter 22, an inverter 23, a motor generator 25, a transmission gear 26, a drive wheel 27, and a controller 30.

Main battery 10 is implemented as an assembled battery (a battery pack) 20 including a plurality of battery modules 11. Each battery module 11 includes a rechargeable secondary battery cell represented by a lithium ion secondary battery.

A current sensor 15, a temperature sensor 16, a voltage sensor 17, and a battery monitoring unit 18 are further arranged in battery pack 20. Battery monitoring unit 18 is implemented, for example, by an electronic control unit (ECU). Battery monitoring unit 18 is also referred to as a monitoring ECU 18 below.

Current sensor 15 detects currents IB input to and output from main battery 10 (hereinafter also referred to as a battery current IB). In the following, in connection with battery current IB, a discharging current is expressed as a positive value and a charging current is expressed as a negative value.

Temperature sensor 16 detects a temperature of main battery 10 (hereinafter also referred to as a battery temperature TB). A plurality of temperature sensors 16 may be arranged. In this case, a weighted average value, a maximal value, or a minimal value of temperatures detected by the plurality of temperature sensors 16 can be used as battery temperature TB or a temperature detected by specific temperature sensor 16 can be used as battery temperature TB. Voltage sensor 17 detects a voltage output from main battery 10 (hereinafter also referred to as a battery voltage VB).

Monitoring ECU 18 receives detection values from current sensor 15, temperature sensor 16, and voltage sensor 17. Monitoring ECU 18 outputs battery voltage VB, battery current IB, and battery temperature TB to controller 30. Alternatively, monitoring ECU 18 can store also data on battery voltage VB, battery current IB, and battery temperature TB in an embedded memory (not shown).

Monitoring ECU 18 is provided with a function to calculate a state of charge (SOC) of main battery 10 by using at least some of battery voltage VB, battery current IB, and battery temperature TB. The SOC is represented by a percentage of a current amount of stored energy to a full charge capacity of main battery 10. Controller 30 which will be described later can also be provided with a function to calculate an SOC.

Main battery 10 is connected to boost converter 22 with system main relays 21a and 21b being interposed. Boost converter 22 boosts an output voltage from main battery 10. Boost converter 22 is connected to inverter 23, which converts direct-current (DC) power from boost converter 22 into alternating-current (AC) power.

Motor generator (three-phase AC motor) 25 generates kinetic energy for running a vehicle by receiving AC power from inverter 23. Kinetic energy generated by motor generator 25 is transmitted to drive wheels 27. When the vehicle is decelerated or stopped, motor generator 25 converts kinetic energy generated during braking of the vehicle into electric energy. AC power generated in motor generator 25 is converted to DC power by inverter 23. Boost converter 22 down-converts an output voltage from inverter 23 and supplies the resultant voltage to main battery 10. Regenerative power can thus be stored in main battery 10. Motor generator 25 is thus configured to generate driving force or braking force of the vehicle with supply and reception of electric power to and from main battery 10 (that is, charging and discharging of main battery 10).

Boost converter 22 does not have to be provided. When a DC motor is employed as motor generator 25, inverter 23 does not have to be provided.

When electrically powered vehicle 100 is implemented by a hybrid car in which an engine (not shown) is further mounted as a motive power source, output from the engine in addition to output from motor generator 25 can be used as driving force for running a vehicle. Alternatively, a motor generator (not shown) generating electric power with output from the engine can also further be mounted to generate electric power for charging main battery 10 with output from the engine.

Controller 30 is implemented, for example, by an electronic control unit (ECU), and includes a control unit 31 and a memory 32. Memory 32 stores a program for operating control unit 31 or various types of data. Memory 32 can also be provided outside controller 30 so long as control unit 31 can read data therefrom and write data therein.

Controller 30 controls operations of system main relays 21a and 21b, boost converter 22, and inverter 23. When an ignition switch (not shown) is switched from off to on, controller 30 switches system main relays 21a and 21b from off to on and operates boost converter 22 and inverter 23. When the ignition switch is switched from on to off, controller 30 switches system main relays 21a and 21b from on to off and stops an operation of boost converter 22 and inverter 23.

Electrically powered vehicle 100 further includes a communication unit 60, an operation unit 70, and an output unit 80.

Operation unit 70 includes an operation switch for a user of electrically powered vehicle 100 to input various operation commands. Operation unit 70 can be implemented by a hardware mechanism such as a push switch or by software such as a touch switch provided on a touch panel. An instruction from a user which has been input to operation unit 70 is input to controller 30.

Output unit 80 is configured to output a visual and/or auditory message to a user of electrically powered vehicle 100 in response to a control command from controller 30. For example, output unit 80 can be implemented as a speaker or a display such as a liquid crystal panel. Operation unit 70 and output unit 80 can also be implemented as an integrated device by employing a touch panel.

Communication unit 60 functions to establish a communication path 210 with the outside of electrically powered vehicle 100 and to establish wireless communication. For example, communication unit 60 can be implemented by a vehicle-mounted wireless communication module.

Electrically powered vehicle 100 can bidirectionally communicate data with data center 250 by connecting to a wide area communication network 240 (representatively the Internet) through communication path 210 by means of communication unit 60.

Data center 250 can also bidirectionally communicate data with a plurality of electrically powered vehicles 100# through wide area communication network 240. Each of the plurality of electrically powered vehicles 100# includes a vehicle-mounted secondary battery, and a deterioration degree of a secondary battery thereof is to be compared with that of electrically powered vehicle 100 (main battery 10) as will be described later. For example, electrically powered vehicle 100# is of the same model as electrically powered vehicle 100 and can be defined as a vehicle incorporating a secondary battery identical in specification to main battery 10 of electrically powered vehicle 100. For distinction from electrically powered vehicle 100 (a subject car), electrically powered vehicle 100# is simply also referred to as “other car” below. Main battery 10 mounted on electrically powered vehicle 100 is also simply referred to as a “subject battery” and a secondary battery (a main battery) mounted on electrically powered vehicle 100# is also simply referred to as an “other battery.”

Electrically powered vehicle 100 may be configured to be provided with an external charging function to charge main battery 10 with an external power supply 40. In this case, electrically powered vehicle 100 further includes a charger 28 and charge relays 29a and 29b.

External power supply 40 is a power supply provided outside a vehicle, and for example, a commercial AC power supply can be applied as external power supply 40. Charger 28 converts electric power from external power supply 40 to charging power for main battery 10. Charger 28 is connected to main battery 10 with charge relays 29a and 29b being interposed. When charge relays 29a and 29b are turned on, main battery 10 can be charged with electric power from external power supply 40.

External power supply 40 and charger 28 can be connected to each other, for example, through a charging cable 45. As external power supply 40 and charger 28 are electrically connected to each other when charging cable 45 is attached, main battery 10 can be charged with external power supply 40. Alternatively, electrically powered vehicle 100 may be configured such that electric power is transmitted between external power supply 40 and charger 28 in a contactless manner. For example, main battery 10 can be charged by external power supply 40 by transmitting electric power through a power transmission coil (not shown) on a side of the external power supply and a power reception coil (not shown) on a side of the vehicle.

In an example where AC power is thus supplied from external power supply 40, charger 28 is configured to be provided with a function to convert supply power (AC power) from external power supply 40 to charging power (DC power) for main battery 10. Alternatively, in an example where external power supply 40 directly supplies charging power for main battery 10, charger 28 should only transmit DC power from external power supply 40 to main battery 10. A manner of external charging of electrically powered vehicle 100 is not particularly limited.

Electrically powered vehicle 100 runs while main battery 10 is charged and discharging. When the electrically powered vehicle is provided with the external charging function, main battery 10 is charged while electrically powered vehicle 100 is parked. As electrically powered vehicle 100 is thus used, main battery 100 deteriorates over time. Progress of deterioration of main battery 10, however, has been known to significantly vary depending on a history of patterns of driving by a driver or temperature states of main battery 10.

Therefore, in the electrically powered vehicle according to the present embodiment, deterioration of main battery 10 is diagnosed as below.

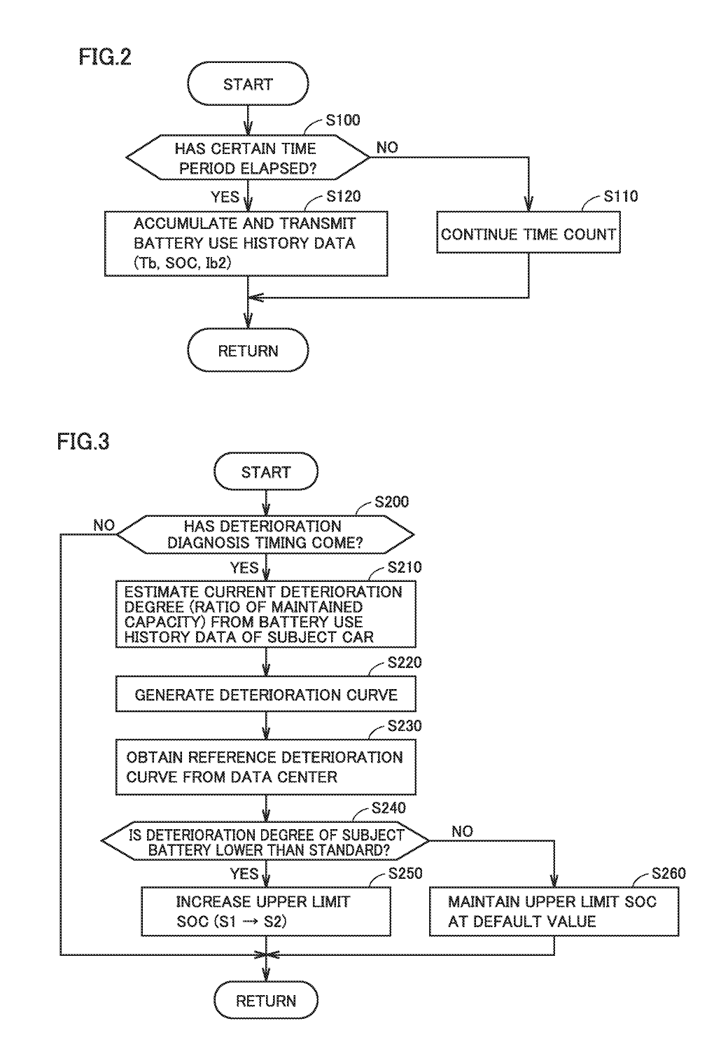

FIG. 2 is a flowchart for illustrating processing for accumulating battery use history data of the electrically powered vehicle. Processing in accordance with the flowchart shown in FIG. 2 can be performed by controller 30.

Referring to FIG. 2, controller 30 determines in step S100 whether or not a certain time period has elapsed since previous transmission of battery use history data. For example, a not-shown timer contained in controller 30 can count an elapsed time since previous transmission of battery use history data. For example, the certain time period can be set to approximately 1 hour.

Controller 30 has the timer continue counting in step S110 until the certain time period elapses (determination as NO in S100). As shown in FIG. 1, controller 30 can obtain battery current IB, battery voltage VB, and battery temperature TB as well as an SOC of main battery 10 at any timing by means of monitoring ECU 18.

When the certain time period has elapsed (determination as YES in S100), in S120, controller 30 has memory 32 accumulate battery use history data of main battery 10. For example, data on current values of battery temperature TB and an SOC and a battery current square value (IB²) indicating a battery load can be accumulated as battery use history data. In step S120, a value of count by the timer is cleared as battery use history data is accumulated.

The battery use history data can be data on an instantaneous value at each timing every time a certain time period elapses. Alternatively, data resulting from statistical processing of battery temperature TB, an SOC, and a battery load (for example, an average value) within the certain time period may be stored in memory 32 as battery use history data. Consequently, controller 30 can diagnose deterioration of the subject battery using the battery use history data since start of use of main battery 10 (a new battery) stored in memory 32. The battery use history data is transmitted to data center 250 through communication unit 60.

The processing shown in FIG. 2 is performed throughout running (an ignition switch being on) and non-running (the ignition switch being off) of the electrically powered vehicle. The processing in FIG. 2 is performed also while electrically powered vehicle 100 is being parked and let stand and while electrically powered vehicle 100 is externally charged, and a time period of use of the secondary battery (main battery 10) includes both of a time period of running and a time period of non-running of electrically powered vehicle 100. Thus, use history data of main battery 10 can periodically be transmitted to data center 250 as a certain time period elapses.

The control processing shown in FIG. 2 is performed also in each electrically powered vehicle 100# (other car). Consequently, battery use history data of main batteries of a plurality of vehicles including the subject car (electrically powered vehicle 100) is transmitted to data center 250.

FIG. 3 is a flowchart illustrating control processing for diagnosing deterioration of the secondary battery (main battery 10) in electrically powered vehicle 100. The control processing shown in FIG. 3 can also be performed by controller 30.

Referring to FIG. 3, controller 30 determines in step S200 whether or not prescribed deterioration diagnosis timing has come. When the deterioration diagnosis timing has come (determination as YES in step S200), the process proceeds to step S210 and deterioration diagnosis processing is started. The control processing shown in FIG. 3 can be performed in such a manner that processing in step S210 or later is started as being triggered by sensing of arrival of deterioration diagnosis timing.

For example, deterioration diagnosis timing can be set to come in a certain cycle (for example, each time a prescribed number of months or years elapse). For example, determination in step S200 can be made in such a manner that arrival of deterioration diagnosis timing is sensed each time the control processing shown in FIG. 2 is performed a prescribed number of times.

In general, a secondary battery is often fast in progress of deterioration in an early stage after start of use thereof and a rate of progress of deterioration becomes stable after lapse of approximately one year. Therefore, in step S200, determination as NO may be maintained for approximately one year after start of use of main battery 10.

Controller 30 estimates in step S210 a current deterioration degree of main battery 10 by using battery use history data of the subject car stored in memory 32. In the present embodiment, by way of example, a deterioration degree of the secondary battery is quantitatively evaluated by using a “ratio of maintained capacity” defined as a percentage of a current full charge capacity (Ah) with respect to a full charge capacity at the time when the battery was new. It is understood from this definition that a higher ratio of maintained capacity means a lower deterioration degree of the secondary battery and a lower ratio of maintained capacity means a higher deterioration degree of the secondary battery.

As described above, an SOC of the secondary battery represents in percentage a ratio of a current amount of stored power to a current full charge capacity. Therefore, in an example where the full charge capacity itself has become low due to a ratio of maintained capacity <1.0, an actual amount of stored power (Ah) has become low even though a value for an SOC is the same (for example, SOC=100%).

One example of processing for estimating a deterioration degree of main battery 10 will now be described with reference to FIGS. 4 to 6.

FIG. 4 is a scatter diagram of an SOC (%) and a battery temperature Tb representing battery use history data accumulated in the control processing shown in FIG. 2. The abscissa in FIG. 4 represents an SOC (%) and the ordinate in FIG. 4 represents a battery temperature (° C.).

Referring to FIG. 4, combination of battery temperature TB and an SOC (%) in battery use history data obtained at each timing is obtained as each plot in the scatter diagram. The scatter diagram in FIG. 4 shows tendency of use of main battery 10 in connection with at which temperatures and SOCs they have been used so far. Depending of a condition of use of a vehicle so far, the scatter diagram shown in FIG. 4 is different for each vehicle.

FIG. 5 is a histogram of battery temperatures TB in a certain SOC range obtained from the scatter diagram shown in FIG. 4.

For example, FIG. 5 shows a distribution of frequencies for each range set in 10 (° C.) increments of battery temperature TB by using the battery use history data in a range of SOCs from 70 to 80 (%) in FIG. 4. A distribution of frequencies similar to that in FIG. 5 can be found for each SOC (%) range.

Since a frequency of appearance of each SOC range can be found, in each SOC range, a probability of occurrence for each region of use defined by a combination of an SOC range and a battery temperature range can be found based on multiplication of the frequency of appearance by the distribution of frequencies for each battery temperature range as in FIG. 5.

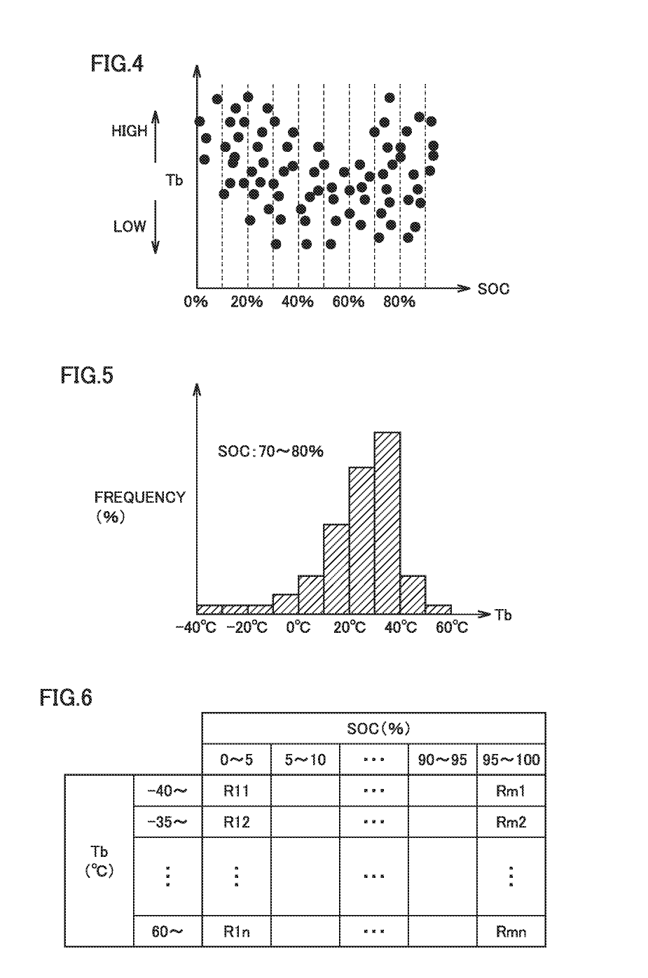

FIG. 6 shows a table illustrating exemplary definition of a region of use of a secondary battery.

Referring to FIG. 6, m×n regions of use R11 to Rmn can be defined based on combination between m (m: a natural number not smaller than 2) SOC ranges set in 5 (%) increments and n (n: a natural number not smaller than 2) battery temperature ranges set in 5 (° C.) increments.

As described above, a probability of appearance of m SOC ranges can be found and a distribution of frequencies in a battery temperature range set in 5 (° C.) increments can be found in each SOC range. Therefore, frequencies of occurrence P11 to Pmn corresponding to respective regions of use R11 to Rmn can be calculated in accordance with a product of the probability of appearance of each SOC range and the frequency of appearance of each battery temperature range in the SOC range. The total sum of frequencies of occurrence P11 to Pmn is 1.0.

In general, a secondary battery has been known to be higher in rate of progress of deterioration over time when a high-temperature and high-SOC condition continues. With such characteristics of the secondary battery being reflected, in each of regions of use R11 to Rmn, a unit degree of progress of deterioration when main battery 10 is used for a unit time period (for example, 1 hour) in each region can be determined in advance. The unit deterioration progress degree is represented by an amount of lowering (%/h) in ratio of maintained capacity per unit time. Thus, memory 32 stores in advance unit deterioration progress degrees C11 to Cmn in correspondence with respective regions of use R11 to Rmn.

With the use of a cumulative time period Tt (h) from start of use of main battery 10, time periods of use in regions of use R11 to Rmn are shown as Tt·P11 to Tt·Pmn.

Then, a deterioration degree parameter R of main battery 10 at the current time point can be calculated in accordance with an expression (1) below by totaling the products of unit deterioration progress degrees C11 to Cnm and respective time periods of use in regions of use R11 to Rmn.

R=1.0−Tt·(P11·C11+ . . . +Pmn·Cmn) (1)

Deterioration degree parameter R corresponds to an estimated value for a ratio of maintained capacity at the current time point. When main battery 10 is new, a condition of R=1.0 (that is, a ratio of maintained capacity being 100 (%)) is satisfied. It is understood that “1.0−R” in connection with deterioration degree parameter R in the expression (1) corresponds to a rate of lowering (that is, a deterioration degree) in full charge capacity from start of use. A deterioration degree of a secondary battery is estimated below by using deterioration degree parameter R, and smaller deterioration degree parameter R means a higher deterioration degree of main battery 10.

The expression (1) above can also be deformed to further combine estimation of a deterioration degree due to charging and discharging cycles, by using history data of a battery load (Ib²). Controller 30 can estimate a deterioration degree of main battery 10 of the subject car at the current time point at each deterioration diagnosis timing by calculating such deterioration degree parameter R (step S210). FIGS. 4 to 6 merely illustrate one example of processing for estimating a deterioration degree, and the processing in step S210 can be performed with any technique so long as a deterioration degree parameter for quantitatively estimating a current deterioration degree can be calculated based on past battery use history data.

Referring again to FIG. 3, controller 30 estimates in step S220 a deterioration curve of the subject battery by using current deterioration degree parameter R found in step S210.

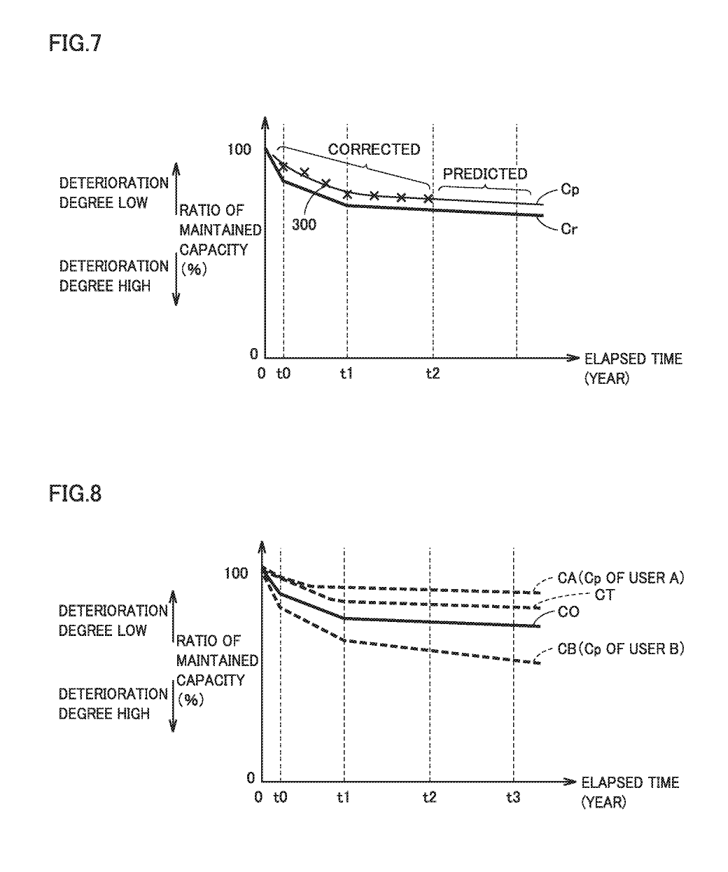

FIG. 7 shows a conceptual graph illustrating exemplary estimation of a deterioration curve in step S220. The abscissa in FIG. 7 represents an elapsed time (a time period of use) since start of use of main battery 10 and the ordinate represents a ratio of maintained capacity (%) in accordance with deterioration degree parameter R.

Referring to FIG. 7, a period until an elapsed time reaches t0 corresponds to an initial period during which deterioration progresses fast described above. For example, t0 is approximately one year. Therefore, deterioration is not diagnosed until the elapsed time reaches t0.

A reference deterioration curve Cr shown with a bold line in FIG. 7 is determined in advance based on characteristics of main battery 10. For example, reference deterioration curve Cr can be laid down in advance based on data on deterioration over time in experiments under a standard history of use. For example, information for defining reference deterioration curve Cr can be stored in memory 32. In FIG. 7, a ratio of maintained capacity (deterioration degree parameter R) estimated in step S210 (FIG. 3) each time deterioration diagnosis timing comes is plotted with a reference 300. In the example in FIG. 7, deterioration is diagnosed seven times until lapse of t2.

For example, a deterioration curve of the subject battery can be estimated, with prediction after t2 being included, by correcting a rate of progress of deterioration (reference) along reference deterioration curve Cr with an estimated value for a ratio of maintained capacity obtained in diagnosis of deterioration so far.

Referring again to FIG. 3, when controller 30 estimates a deterioration curve of the subject battery in step S220, it accesses data center 250 in step S230 to obtain a standard deterioration curve.

Here, deterioration degree parameter R (a ratio of maintained capacity) calculated in step S210 can also be transmitted to data center 250. In the present embodiment, at least one of battery use history data (S120 in FIG. 2) and deterioration degree parameter R (S210 in FIG. 3) is periodically transmitted as “information on secondary batteries” from electrically powered vehicles 100 and 100# to data center 250.

Data center 250 generates a standard deterioration curve based on battery use histories from a plurality of users of secondary batteries identical in type to main battery 10, by using information on the secondary batteries transmitted from a plurality of electrically powered vehicles 100# (incorporating the secondary batteries identical in specification to main battery 10). The standard deterioration curve can be updated in response to transmission of information from each of electrically powered vehicles 100 and 100#. For example, the standard deterioration curve corresponds to an aggregate of standard deterioration degrees after time periods of use at each time point in a plurality of electrically powered vehicles which have transmitted information on the secondary batteries to data center 250. The standard deterioration degree can be set, for example, as an aggregate of average values or median values of deterioration degree parameters R (ratios of maintained capacity) of a plurality of electrically powered vehicles.

Data center 250 can calculate deterioration degree parameters R (ratios of maintained capacity) of electrically powered vehicles 100 and 100# based on battery use history data periodically transmitted from each vehicle as information on the vehicle-mounted secondary battery. Alternatively, as described above, data center 250 may receive transmission of a calculated parameter value each time each vehicle calculates deterioration degree parameter R in the processing (S210) as in FIG. 3.

Referring again to FIG. 3, controller 30 compares in step S240 a deterioration degree of the subject car in accordance with the deterioration curve (S220) with the standard deterioration degree in accordance with the standard deterioration curve (S230) from data center 250.

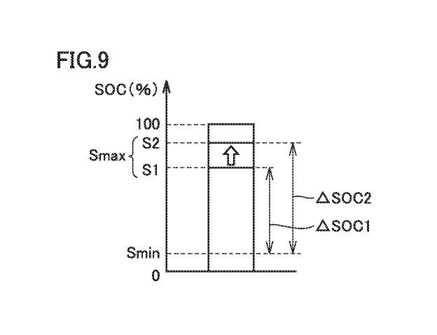

FIG. 8 shows a conceptual graph illustrating one example of processing for comparing a deterioration degree in step S240.

Referring to FIG. 8, a determination threshold value Ct at each elapsed time can be set based on a standard deterioration curve CO from data center 250.

For example, determination threshold value Ct can be set by multiplying a value for each deterioration degree parameter R on standard deterioration curve CO by k (k>1.0) or by adding thereto a prescribed margin value. The margin value can also be set, with variation (standard deviation) in deterioration degree parameter R at the same elapsed time among a plurality of vehicles used for setting of standard deterioration curve CO being reflected. FIG. 8 shows a deterioration determination curve CT corresponding to an aggregate of determination threshold values Ct with a dotted line.

Therefore, standard deterioration curve CO and a deterioration curve Cp of the subject car can be compared with each other in step S240 by comparing deterioration determination curve CT with deterioration curve Cp (FIG. 7) of the subject car.

When a ratio of maintained capacity represented by deterioration curve Cp is higher than a ratio of maintained capacity represented by deterioration determination curve CT, a deterioration degree of the subject battery is determined as being lower than the standard deterioration degree. Therefore, on a deterioration curve CA (Cp) for a user A exemplified in FIG. 8, the deterioration degree of the subject battery is determined as being lower than the standard. On a deterioration curve CB (Cp) for a user B, the deterioration degree of the subject battery is determined as being higher than the standard deterioration degree.

A period during which comparison between deterioration degrees represented by deterioration determination curve CT and the deterioration curve of the subject battery is made can arbitrarily be determined. For example, a period during which comparison of a deterioration degree is made can be set to include both of a period until the current time point (until t2 in FIG. 7) and a portion after the current time point (after t2 in FIG. 7), and then determination in step S240 can be made. Alternatively, a period during which comparison of a deterioration degree is made may be set to include only one of a period until the current time point (until t2 in FIG. 7) and a period after the current time point (after t2 in FIG. 7).

Alternatively, most simply, determination in step S240 can also be made based on comparison between deterioration degree parameter R and determination threshold value Ct based on the standard deterioration degree (that is, one point on standard deterioration curve CO) at the present deterioration diagnosis timing. In contrast, determination in step S240 can more highly accurately be made with prediction of a deterioration degree after the current time point being reflected, based on comparison between deterioration curve Cp and standard deterioration curve CO (deterioration determination curve CT).

Referring again to FIG. 3, when controller 30 determines that the deterioration degree of the subject battery is lower than the standard (determination as YES in S240), the process proceeds to step S250 and an upper limit SOC corresponding to an upper limit value for an SOC control range of main battery 10 is increased from a default value (S1) to a prescribed value S2 (S2>S1).

When controller 30 does not determine that the deterioration degree of the subject battery is lower than the standard (determination as NO in S240), the process proceeds to step S260 and the upper limit SOC is maintained at the default value (S1).

When a ratio of maintained capacity represented by deterioration curve Cp is higher than the ratio of maintained capacity represented by deterioration determination curve CT throughout the period during which comparison of the deterioration degree is made described above, determination as YES can be made in step S240. Alternatively, when a ratio of maintained capacity represented by deterioration curve Cp is higher than a ratio of maintained capacity represented by deterioration determination curve CT in a part of the period in which comparison of the deterioration degree is made under a predetermined condition as well, determination as YES can be made in step S240.

FIG. 9 is a conceptual diagram illustrating SOC control based on a result of diagnosis of deterioration of the secondary battery in the electrically powered vehicle according to the present embodiment.

Referring to FIG. 9, an SOC of main battery 10 is controlled to be within a range from a lower limit SOC (Smin) to an upper limit SOC (Smax) between 0 and 100 (%). For example, when the SOC increases to the upper limit SOC during running of the vehicle, controller 30 prohibits charging of main battery 10. Thus, regeneration by motor generator 25 is prohibited, necessary braking force is ensured by a friction brake (not shown), and energy cannot be recovered during deceleration. When the SOC reaches the upper limit SOC (Smax) also during external charging with charger 28, controller 30 deactivates charger 28 and quits charging.

When the SOC lowers to the lower limit SOC, controller 30 prohibits discharging of main battery 10. Thus, the vehicle cannot run with electric power stored in main battery 10. Therefore, it is understood that, as an SOC available range defined as a difference between the upper limit SOC (Smax) and the lower limit SOC (Smin) is greater, a travel distance can be increased by making effective use of main battery 10. Default value S1 of the upper limit SOC (Smax) is set within a region where the possibility of progress of deterioration is relatively low even when the main battery is let stand, in consideration of characteristics of main battery 10.

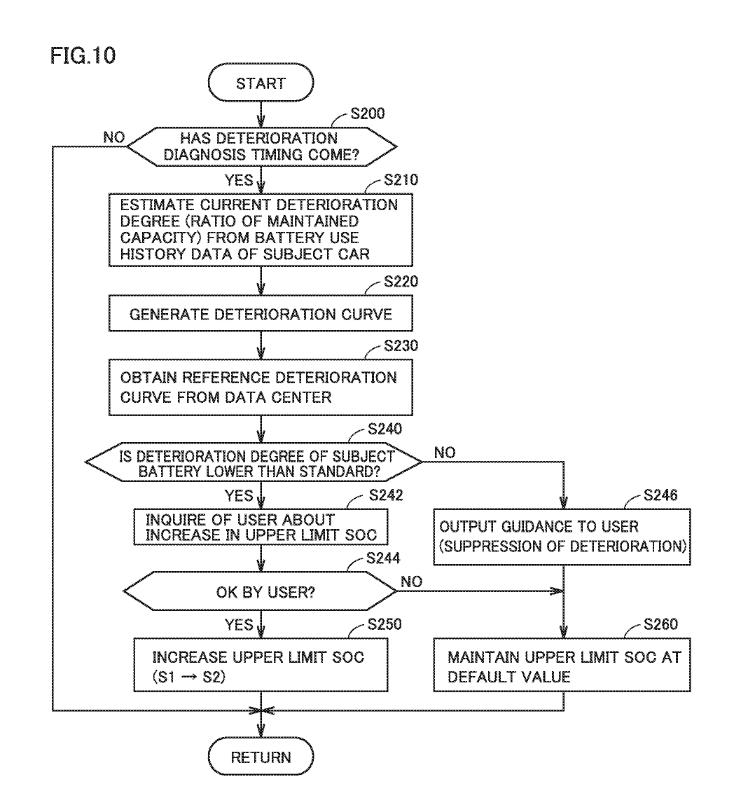

An SOC available range ΔSOC2 at the time when the upper limit SOC (Smax) is increased from default value S1 to prescribed value S2 in step S250 in FIG. 10 is greater than an SOC available range ΔSOC1 at the time when the upper limit SOC (Smax) is set to default value S1. Thus, for an electrically powered vehicle in which a deterioration degree of its own battery is lower than the standard, an SOC available range can be broadened by making use of a margin for the standard deterioration degree. Though the possibility of progress of deterioration relatively increases with increase in upper limit SOC (Smax), increase in upper limit SOC is allowed, with the deterioration degree of the own battery being retained within a range not higher than the standard, by making similar determination at each diagnosis timing. The main battery can thus effectively be used.

As described above, according to the electrically powered vehicle in the present embodiment, whether or not a deterioration degree of a subject battery is lower than the standard can highly accurately be estimated by using actual information on secondary batteries in a plurality of vehicles. Furthermore, based on such highly accurate estimation, main battery 10 lower in deterioration degree than the standard can be made effective use of by broadening the SOC available range.

In particular, by comparing a deterioration degree of a subject secondary battery with the standard deterioration degree with prediction of a deterioration degree after the current time point being reflected by using deterioration curve Cp and standard deterioration curve CO, whether or not the upper limit SOC may be increased can further highly accurately be determined.

(Modification)

FIG. 10 is a flowchart illustrating a modification of diagnosis of deterioration of the secondary battery (main battery 10) in the electrically powered vehicle according to the present embodiment.

Referring to FIG. 10, when controller 30 senses arrival of timing of deterioration diagnosis in step S200 as in FIG. 3, it performs steps S210 to S240 as in FIG. 3 and determines whether or not the deterioration degree of the subject battery is lower than the standard. Since the control processing up to here is the same as in FIG. 3, detailed description will not be repeated.

When controller 30 determines that the deterioration degree of the subject battery is lower than the standard (determination as YES in step S240), the process proceeds to step S242. Controller 30 notifies that the upper limit SOC may be increased because the deterioration degree of the subject battery is low and outputs a message for checking with a user whether or not to permit increase in upper limit SOC. The message can be provided, for example, by representation on a screen and/or output of sound through output unit 80 shown in FIG. 1.

Controller 30 determines in step S244 whether or not an instruction from a user permitting increase in upper limit SOC has been input to operation unit 70 in response to output of the message in step S242. For example, in response to the message in step S242, a touch switch for input can be shown on a touch panel so that determination in step S244 can be made based on whether or not the touch switch is operated.

When an instruction from a user permitting increase in upper limit SOC has been input to operation unit 70 (determination as YES in S244), the process proceeds to step S250 as in FIG. 3 and the upper limit SOC (Smax) is increased from default value S1 to S2 as shown in FIG. 9.

When an instruction from a user permitting increase in upper limit SOC has not been input (determination as NO in S244), controller 30 maintains the upper limit SOC at default value S1 in step S260 as in FIG. 3.

Thus, the user can select which of effective use of main battery 10 (increase in travel distance) and protection against deterioration is to be prioritized, in consideration of the fact that broadening of the SOC available range is disadvantageous to deterioration of main battery 10.

Furthermore, when controller 30 does not determine that the deterioration degree of the subject battery is lower than the standard (determination as NO in S240), it fixes the upper limit SOC at the default value in step S260 and outputs guidance for suppressing deterioration of main battery 10 in step S246.

User guidance in step S246 can be given based on battery use history data accumulated in memory 32. For example, though a frequency of occurrence of high battery temperature TB becomes higher in main battery 10 high in deterioration degree, which of charging and discharging during running of a vehicle and parking in a high-temperature environment is a main cause for high battery temperature TB can be determined based on combination of a battery load (IB²) and battery temperature TB. Therefore, when influence by parking in a high-temperature environment is greater, guidance for selecting a parking position at which direct sunlight can be avoided can be output.

Alternatively, when it can be determined that a period after external charging in which the SOC has attained to the upper limit is long based on a distribution of frequencies of occurrence of the SOC, guidance encouraging timer-controlled charging can be output in order to shorten a time period from end of external charging until start of running of the vehicle. Thus, improvement in environment for use for suppressing deterioration of main battery 10 can be encouraged.

In FIG. 10, such control processing that any one of output of guidance in step S246 and checking of an operation by a user in steps S242 and S244 is performed can also be performed. Step S246 may be performed only when a deterioration determination curve is separately prepared under standard deterioration curve CO (on a side of a high deterioration degree) (FIG. 8) and a deterioration degree represented by deterioration curve Cp is higher than the deterioration degree represented by the deterioration determination curve.

Thus, according to the modification shown in FIG. 10, convenience of a user of electrically powered vehicle 100 can be enhanced by further providing a function for allowing a user to select whether or not to increase the upper limit SOC at the time when the deterioration degree of main battery 10 is lower than the standard and/or a function to output guidance at the time when the deterioration degree of main battery 10 is higher than the standard.

The configuration of electrically powered vehicle 100 in FIG. 1 is merely by way of illustration, and the present disclosure is applicable also to an electrically powered vehicle other than an electric car, such as a hybrid vehicle incorporating an engine or a fuel cell in addition to main battery 10, without a configuration of a powertrain being particularly limited. Deterioration diagnosis processing according to the present embodiment is applicable to a secondary battery mounted as a motive power source in an electrically powered vehicle.

FIGS. 3 and 10 illustrate examples in which controller 30 of electrically powered vehicle 100 estimates a current deterioration degree, that is, calculates a deterioration degree parameter. When battery use history data is periodically transmitted to data center 250 as in FIG. 2, however, data center 250 may estimate a deterioration degree of main battery 10 of electrically powered vehicle 100. In this case, in step S210 in FIG. 3, a deterioration degree parameter is obtained through communication with data center 250. Furthermore, data center 250 may generate also a deterioration curve in addition to a deterioration degree parameter. In step S220 in FIG. 3, controller 30 may obtain a deterioration curve through communication with data center 250. Alternatively, controller 30 may generate deterioration curve Cp (FIG. 7) through processing in step S220 described above by using a deterioration degree parameter obtained through communication with data center 250.

Furthermore, the deterioration degree parameter is not limited to a deterioration degree parameter representing a ratio of maintained capacity exemplified in the present embodiment. So long as a deterioration degree parameter quantitatively represents a deterioration degree of a secondary battery and can be calculated from battery use history data, any parameter value can be used as a deterioration degree parameter in diagnosis of deterioration of a secondary battery in the electrically powered vehicle according to the present embodiment.

The present embodiment shows an example that a plurality of electrically powered vehicles 100# of which deterioration degrees of secondary batteries are to be compared with that of electrically powered vehicle 100 (main battery 10) are identical in model to electrically powered vehicle 100 and include vehicle-mounted secondary batteries identical in specification to main battery 10. Electrically powered vehicle 100#, however, can also include a vehicle different in model and/or specification of a secondary battery from electrically powered vehicle 100 by introducing normalization for converting a difference in number of cells in a secondary battery or weight of the vehicle in comparison of a deterioration degree parameter. By comparing a normalized deterioration parameter, a deterioration degree of a secondary battery according to the present embodiment can be compared between vehicles different in model and/or specification of the secondary battery.

For example, until information on a prescribed number of secondary batteries which are mounted on vehicles identical in model to electrically powered vehicle 100 and are identical in specification to main battery 10 is collected in data center 250, in order to secure the number of subjects to be compared, a vehicle different in model and/or specification of a secondary battery can be included in a plurality of electrically powered vehicles 100# so that a deterioration degree can be compared based on a normalized value. Then, after information on at least a prescribed number of secondary batteries identical in specification which are mounted on vehicles identical in model is secured, subjects of which deterioration degree is to be compared (that is, an extent of a plurality of electrically powered vehicles 100#) can be changed so that a deterioration degree is compared among secondary batteries identical in specification which are mounted on vehicles identical in model.

“Information on secondary batteries” transmitted from a plurality of electrically powered vehicles 100# to data center 250 is not limited to battery use history data and/or a deterioration degree parameter described above, but any information can be employed so long as it is quantitative data which can directly or indirectly be used for comparison of a deterioration degree.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. An electrically powered vehicle comprising:
a secondary battery mounted as a motive power source;
a memory configured to accumulate use history data of the secondary battery;
a communicator configured to communicate with a data center outside the electrically powered vehicle; and
a controller configured to control charging and discharging of the secondary battery so as to maintain an SOC of the secondary battery within a control range,
the data center being configured to receive information on vehicle-mounted secondary batteries from a plurality of vehicles each provided with the vehicle-mounted secondary battery and to calculate a standard deterioration degree over time of the secondary batteries by using the information from the plurality of vehicles, and
the controller being configured to obtain the standard deterioration degree from the data center at prescribed deterioration diagnosis timing and to increase an upper limit value of the control range of the SOC when a deterioration degree estimated from the use history data of the electrically powered vehicle is lower than the standard deterioration degree.

2. The electrically powered vehicle according to claim 1, wherein
the controller is configured to generate a deterioration curve of the secondary battery including prediction of a deterioration degree after a current time point by correcting a reference deterioration curve showing predetermined change over time in degree of deterioration of the secondary battery by using the estimated deterioration degree until the current time point,
the data center is configured to generate a standard deterioration curve corresponding to an aggregate of the standard deterioration degrees after time periods of use of the secondary batteries at each time point by using the information from the plurality of vehicles, and
the controller increases the upper limit value when a deterioration degree in a portion after the current time point in the deterioration curve is lower than a deterioration degree in a portion after the current time point in the standard deterioration curve.

3. The electrically powered vehicle according to claim 1, the electrically powered vehicle further comprising an operation unit for a user of the electrically powered vehicle to input an instruction, wherein
the controller increases the upper limit value based on comparison of the deterioration degree only when the user inputs the instruction to permit increase in the upper limit value into the operation unit.

4. The electrically powered vehicle according to claim 1, the electrically powered vehicle further comprising an output unit for outputting guidance information to a user of the electrically powered vehicle, wherein
the controller outputs guidance information for suppressing deterioration of the secondary battery in the electrically powered vehicle from the output unit when the estimated deterioration degree of the secondary battery is higher than the standard deterioration degree.

5. A method of controlling an electrically powered vehicle including a secondary battery mounted as a motive power source and a memory configured to accumulate use history data of the secondary battery, the method comprising:
controlling charging and discharging of the secondary battery so as to maintain an SOC of the secondary battery within a control range;
communicating at prescribed deterioration diagnosis timing with a data center configured to receive information on vehicle-mounted secondary batteries from a plurality of vehicles each provided with the vehicle-mounted secondary battery and to calculate a standard deterioration degree over time of the secondary batteries by using the information from the plurality of vehicles and obtaining the standard deterioration degree from the data center; and
increasing an upper limit value of the control range of the SOC when a deterioration degree estimated from the use history data in the electrically powered vehicle is lower than the standard deterioration degree.
